(19) United States
(12) Patent Application Publication
(10) Pub. No.: US 2009/0168958 A1
(43) Pub. Date: Jul. 2, 2009

(54) APPARATUS AND METHOD FOR IDENTIFYING COMPONENTS IN A CONTAINER

(76) Inventors: Cristina Francesca Cozzini, Munchen (DE); Marko Klaus Baller, Munchen (DE); Geoffrey Harding, Hamburg (DE)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 12/258,681

(22) Filed: Oct. 27, 2008

Related U.S. Application Data
(60) Provisional application No. 61/018,501, filed on Jan. 2, 2008.

(51) Int. Cl. G01N 23/04; G01N 23/201

(52) U.S. Cl. 378/57; 378/88

(57) ABSTRACT

A scanner includes a transmission detector, an x-ray source positioned to emit a beam of x-rays toward the transmission detector, and a scatter detector positioned to receive x-rays scattered from the beam of x-rays by an object. The scanner includes a computer programmed to receive data from the transmission detector and from the scatter detector, and determine a material composition of the object based on the data received from the transmission and scatter detectors.

### CROSS-REFERENCE TO RELATED APPLICATION

The present application is a non-provisional of, and claims priority to, U.S. Provisional Application 61/018,501 filed Jan. 2, 2008, the disclosure of which is incorporated herein.

### GOVERNMENT LICENSE RIGHTS

The U.S. Government has a paid-up license in this invention and the right in limited circumstances to require the patent owner to license others on reasonable terms as provided for by the terms of Government Contract No. BAA06-00063 (revised) awarded by the USA Department of Homeland Security.

### BACKGROUND OF THE INVENTION

Embodiments of the invention relate generally to x-ray diffraction (XRD) systems and, more particularly, to an x-ray source and detector configuration for identifying threat components in a container.

In recent years, the detection of contraband, such as explosives, being transported in luggage and taken onto various means of transportation has become increasingly important. To meet the increased need for such detection, advanced Explosives Detection Systems (EDSs) have been developed that can not only detect suspicious articles being carried in the luggage, but can also determine whether or not the articles contain explosives.

To acquire detailed and highly selective information on luggage being scanned, explosives detection devices based on x-ray diffraction (XRD) can be employed. XRD is a known technique for material-specific analysis and is used in security screening applications to detect bulk explosives because it provides diffraction patterns characteristic of the molecular interference function of the object. However, Home Made Explosives (HME) detection at, for instance, aviation checkpoints may be difficult to detect because of the wide variety of liquids, gels, and amorphous solids that passengers typically carry with them, because of the wide variety of containers they come in, and because of the relatively small target amounts that may pose a hazard.

Additionally, a monochromatic source may be used in a system for identifying such materials. However, such a system typically has an inordinate amount of scanning time due to the lower flux, and such a system would have a very large detector to provide position-sensitivity.

Thus, although known techniques and apparatus may exist for detecting bulk explosives, none is capable of screening the wide variety of liquids, gels, and amorphous solids through the types of containers, both metallic and non-metallic, which may be used to carry such materials, at a throughput demanded by today's aviation industry.

Therefore, it would be desirable to design a system and method capable of screening metallic and non-metallic containers for a wide variety of liquids, gels, and amorphous solids that may pose a security threat.

### SUMMARY

Embodiments of the invention provide an apparatus and method that overcome at least one of the aforementioned drawbacks. A system and method is disclosed that includes an object positioned to receive x-rays from an x-ray source, and detectors positioned to receive x-rays that pass through the object and x-rays that scatter from the object. Data received in both detectors is evaluated to determine a material composition of the object.

According to one aspect of the invention, a scanner includes a transmission detector, an x-ray source positioned to emit a beam of x-rays toward the transmission detector, and a scatter detector positioned to receive x-rays scattered from the beam of x-rays by an object. The scanner includes a computer programmed to receive data from the transmission detector and from the scatter detector, and determine a material composition of the object based on the data received from the transmission and scatter detectors.

In accordance with another aspect of the invention, a method of scanning an object includes emitting x-rays toward an object and in a first direction from an x-ray source, receiving x-rays in a first detector that pass through the object along the first direction, and receiving x-rays in a second detector that are scattered by the object along a second direction. The method includes determining a composition of the object based on the x-rays received in the first and second detectors.

Yet another aspect of the invention includes a computer readable storage medium having stored thereon a program configured to cause x-rays to emit from a source toward an object, and receive data from a first detector, the first detector positioned to receive x-rays that pass through the object. The program is configured to receive data from a second detector, the second detector positioned to receive x-rays that scatter from the object, and determine a composition of the object based on the data received from the first and second detectors.

These and other advantages and features will be more readily understood from the following detailed description of preferred embodiments of the invention that is provided in connection with the accompanying drawings.

### BRIEF DESCRIPTION OF THE DRAWINGS

FIG. 1 illustrates a system according to an embodiment of the invention.

FIG. 2 illustrates an x-ray system according to an embodiment of the invention.

FIG. 3 illustrates a collimator for the system of FIG. 2 according to an embodiment of the invention.

FIGS. 4-6 illustrate plan views of elements of the system of FIG. 2 according to embodiments of the invention

FIG. 7 illustrates a technique for identifying components of an object and alerting a user according to embodiments of the invention.

### DETAILED DESCRIPTION OF EXEMPLARY EMBODIMENTS

While embodiments of the invention are described herein with respect to a method and apparatus directed toward identifying liquids in containers and, more particularly, for identifying threat substances such as Home Made Explosives (HME), the method and apparatus described herein may be applicable to identifying a broad range of materials that are not limited to liquids and HMEs. Further, although the method and apparatus are described with respect to a security system at, for example, an aviation checkpoint, the method and apparatus are applicable to other security applications, as well as non-security applications, that could benefit from having the ability to screen metallic and non-metallic containers for liquids, gels, amorphous solids, explosives, and the like.

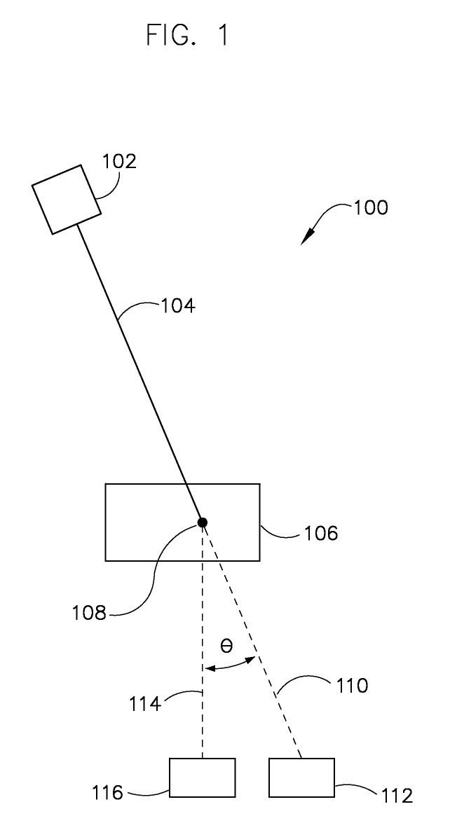

FIG. 1 illustrates a system 100 according to an embodiment of the invention. System 100 includes an x-ray source 102 that is configured to emit a beam of x-rays 104 toward an object 106 to impinge object 106 at location 108. After impinging object 106 at location 108, some of the x-rays pass therethrough as transmission x-rays 110 and impinge upon a transmission detector 112, and some of the x-rays deflect therefrom at small angles θ, such as 4° and 7°, as beams of scatter x-rays 114 and impinge upon a scatter detector 116. In embodiments of the invention, transmission detector 112 is capable of discriminating relatively high- and low-energy x-rays that transmit through object 106, thus providing an effective atomic number Z_{eff}, which is the atomic number of a hypothetical molecular species giving the same attenuation as a compound or mixture being measured. In embodiments of the invention, scatter detector 116 is an energy discriminating detector capable of photon counting.

Thus, data collected in transmission detector 112 and scatter detector 116 may be collectively used to ascertain an effective atomic number, inter-molecular potential, packing fraction, and molecular size of location 108. These features are then compared to those of threat substances that may be stored in a library or database that allows the object 106, or a material therein, to be characterized as belonging to certain functional groups, thus enabling the system 100 to yield a threat decision and alert a user about the threat.

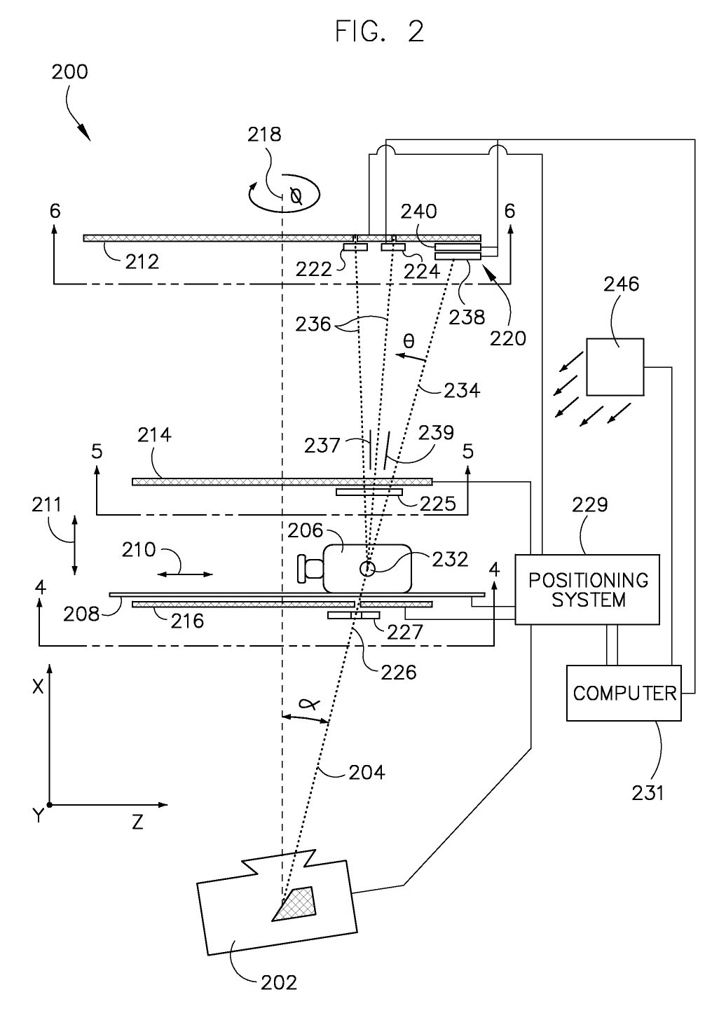

FIG. 2 illustrates an x-ray system 200 according to another embodiment of the invention. X-ray system 200 includes an x-ray source 202 positioned to direct a beam of x-rays 204 toward an object 206. In one embodiment, x-ray source 202 is a low-power, industrial source having a stationary anode and having a power ranging from approximately 0.5 kW to 1.5 kW to emit x-rays up to, in an example, 150 keV. In addition, x-ray source 202 may be a “monoblock” design in which a high-voltage power supply (not shown) is integrated into source 202. In embodiments of the invention, object 206 may be a liquid in a container, a gel in a container, an amorphous substance, an explosive, or an unopened container comprising one of metal, plastic, and glass. System 200 includes an object mover 208 for transporting or moving object 206 along a translation direction 210 to a position suitable for scanning. In one embodiment, mover 208 may be, for example, a conveyor or conveyor belt.

System 200 also includes rotatable turntables 212, 214, 216 that are configured to rotate about an axis of rotation 218. Turntable 212 has mounted thereon a first detector 220, a second detector 222, and a third detector 224. Turntable 214 has mounted thereon a collimator 225 that includes slits for allowing passage of transmission and scatter x-rays, as will be described. Turntable 216 has mounted thereon a primary beam collimator 227. Collimator 227, in this embodiment, includes a slot 226 having dimensions of approximately 5 mm in length by 1 mm in width. In this embodiment, collimator 227 comprises a lead-brass plate 5 mm in thickness. A positioning system 229 is coupled to x-ray source 202, mover 208, and to turntables 212-216. A computer 231 is coupled to and controls positioning system 229 for moving x-ray source 202, object 206 via object mover 208, and turntables 212-216 into position for scanning object 206 as will be described.

Object 206 is positioned via object mover 208, and the turntables 212-216 are controlled in a manner such that the beam of x-rays 204 passes through primary beam collimator 227 and impinges on a sensitive volume 232 of object 206. In one embodiment, sensitive volume 232 is selected to be 10 mm above the turntable 216. However, system 229 may be further configured to move turntable 216 in an X direction 211, thus controlling and altering the location of sensitive volume 232 for imaging with respect to x-ray source 202.

After beam of x-rays 204 passes through sensitive volume 232, a beam of transmission x-rays 234 passes from the object 206 to collimator 225 for collimation and to the first detector 220. Scatter x-rays 236, which are scattered from the object 206 after impinging sensitive volume 232, pass through collimator 225 and pass to second and third detectors 222, 224. Power of the x-ray source 202 is selectable such that some of the x-rays 204 pass through the object 206 and traverse as transmission x-ray beam 234 to detector 220 and such that some of the x-rays scatter from object 206 as scatter x-ray beams 236.

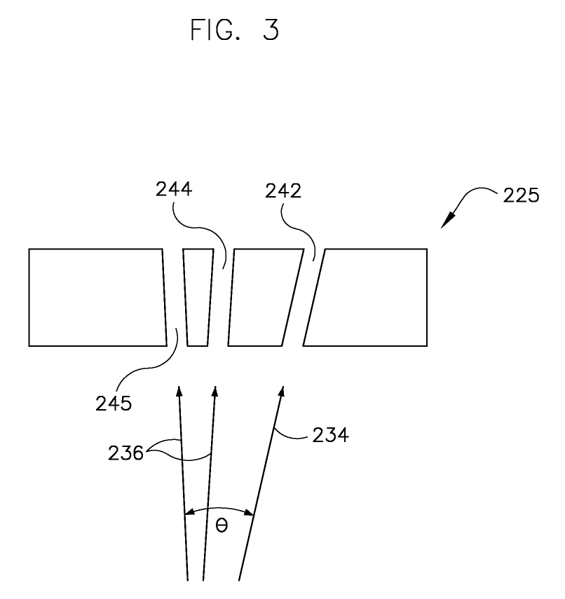

In one embodiment of the invention, first detector 220 comprises a two-layer scintillator having a first layer 238 positioned to receive transmission of an x-ray beam 234 and having a second layer 240 positioned to receive x-rays of transmission x-ray beam 234 that pass through first layer 238. Two-layer detector 220 is capable of discriminating relatively high- and low-energy x-rays that transmit through object 206 as beam of transmission x-rays 234. Low-energy x-rays will impinge and be read by first layer 238, while high-energy x-rays that pass through first layer 238 are detected in second layer 240. As such, because the dominant interaction mechanisms of x-rays ranging from 30 to 150 keV in a material are Compton scattering and the photoelectric effect, first detector 220 can provide atomic number measurements of object 206 in addition to density measurements. First detector 220 thus provides an effective atomic number Z_{eff}, which is the atomic number of a hypothetical molecular species giving the same attenuation as a compound or mixture being measured. Collimator 225, illustrated further in FIG. 3, allows transmission x-ray beam 234 to pass therethrough to first detector 220 and also allows scatter x-rays 236 to pass therethrough to second detector 222 and third detector 224 at preferred angles of 7° and 4°, respectively. In one embodiment, first and second baffles 237, 239 are mounted on turntable 214 and positioned with respect to slits within collimator 225 to prevent x-rays from passing through one slit and going to an unintended detector.

Second and third detectors 222, 224 may comprise CdZnTe and are positioned to receive a pair of scatter x-ray beams 236 scattered from object 206 at scatter angles of 7° and 4° from beam of transmission x-rays 234. In one embodiment, second and third detectors 222, 224 are each single detector elements having a 5 mm by 5 mm area, and in another embodiment, they include a plurality of pixelated elements providing improved resolution over a single detector element. The scatter beams of x-rays 236 pass through collimator 225 prior to impinging the second and third detectors 222, 224. Second and third detectors 222, 224 are energy discriminating detectors capable of photon counting and in one embodiment are spectroscopic detectors having better than 5% energy resolution at 60 keV. The detectors 220, 222, 224 are coupled to the computer 231.

Referring now to FIG. 3, a cross-section of collimator 225 is shown. Collimator 225 includes slots to collimate both the beam of transmission x-rays 234 and the scatter x-rays 236 at their preferred angles of 4° and 7° with respect to the beam of transmission x-rays 234. In one embodiment, collimator 225 includes a transmission slot 242 and first and second scatter slots 244 and 245 at respective angles of 4° and 7° with respect to transmission slot 242. In one embodiment, transmission slot 242 is 1 mm in width and 2 mm in length. Each of the first and second scatter slots 244, 245 is likewise 1 mm in width by 2 mm in length.

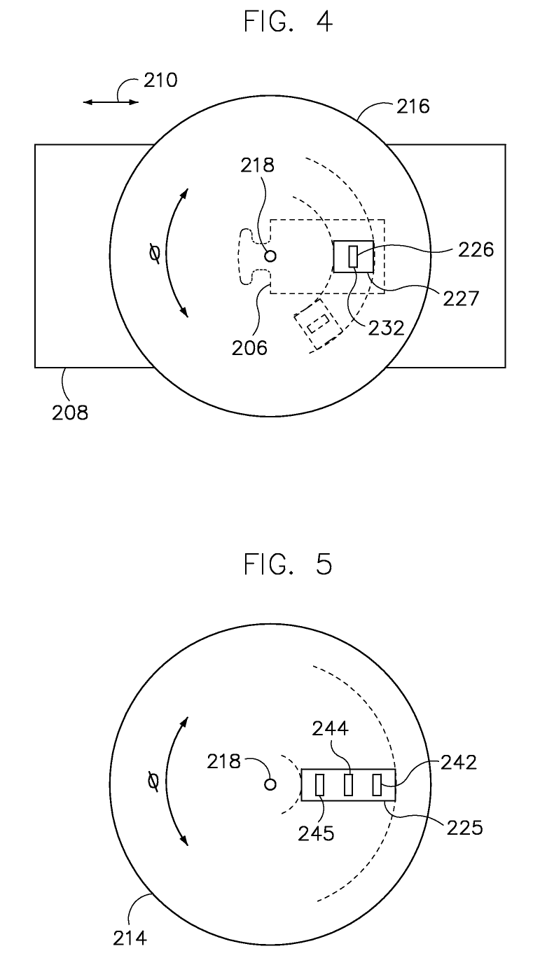

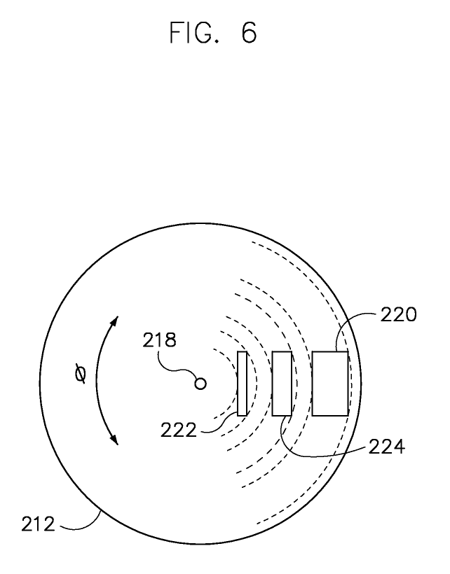

FIGS. 4-6 illustrate plan views of x-ray system 200 along lines 4-4, 5-5, and 6-6, respectively. FIG. 4 illustrates a plan view of turntable 216, FIG. 5 illustrates a plan view of turntable 214, and FIG. 6 illustrates a plan view of turntable 212. Beginning with FIG. 4, turntable 216 includes primary beam collimator 227 having slot 226 therein. Turntable 216 is positioned proximately to object mover 208 that has object 206 positioned thereon. Thus, object mover 208 is able to move object 206 along translation direction 210 while turntable 216 rotates primary beam collimator 227 about axis of rotation 218 and angle Φ. As such, with translation of object mover 208 along translation direction 210 and with the rotation of turntable 216, beam of x-rays 204 can be directed toward object 206, and specifically toward sensitive volume 232.

FIG. 5 illustrates a plan view of turntable 214 having positioned thereon collimator 225. Collimator 225 and collimator slots 242, 244, and 245 may be rotated about axis of rotation 218 and angle Φ. FIG. 6 illustrates a plan view of turntable 212 having positioned thereon first detector 220, second detector 222, and third detector 224. First detector 220, second detector 222, and third detector 224 may be rotated about axis of rotation 218 and angle Φ.

In embodiments of the invention, the mover 208 may be operated in conjunction with positioning system 229 that simultaneously moves components of the system 200, including turntables 212, 214, 216 having thereon, respectively, detectors 220, 222, transmission collimator 225, and primary beam collimator 227, such that the object 206 is positioned for imaging while maintaining preferred relative positioning between the components of the system 200. In one embodiment, the x-ray source 202 likewise moves in conjunction with turntables 212, 214, 216.

In embodiments of the invention, object 206 may be positioned proximate to or within a pathway of the beam of x-rays 204 by an operator who may identify the object 206 by means of a device 246 such as a video camera, a laser pointer, and the like, which is illustrated in FIG. 2 and which is controlled by computer 231. Instead of simply identifying an overall object 206, in one embodiment the operator may more particularly identify sensitive volume 232 of object 206 for scanning. In one embodiment of the invention, device 246 includes a video camera that may be used by an operator to identify the object 206 while recording an image of the object 206 for future reference. In another embodiment, device 246 employs object recognition software to recognize the shape of object 206 and compare the shape to a list of common shapes. Such a system may be operable in automatic mode and without the need of an operator to identify objects to be scanned.

Once object 206 or sensitive volume 232 is identified, object 206 is moved on object mover 208 such that x-rays 204 emitted from x-ray source 202 pass through collimator 227 and impinge upon object 206 at location 232. As illustrated in FIG. 2 and in conjunction with plan views of turntables 212, 214, and 216, and as illustrated in FIGS. 4-6, an operator controls system 200 via computer 231, which is configured to control x-ray source 202, and object mover 208. Computer 231 is also configured to receive data from detectors 220, 222. Thus, an operator may move object 206 in order to receive x-rays from x-ray source 202 as the beam of x-rays 204 is caused to sweep about azimuthal angle Φ and emit x-rays 204 at, in one embodiment, an angle α of approximately 30° to rotation axis 218. The x-rays 204 pass through the collimator 227 and impinge object 206 at position 232 during the sweep.

In one embodiment, power is applied to the source 202, and the sweep is made while the object 206 is stationary. In another embodiment, power is applied to the source 202 while the object 206 is in motion on mover 208 during the sweep. Because of the circular symmetry of the system components about rotation axis 218 and the circular motion of turntables 212-216, constant angles of scatter θ are obtained during the sweep.

As described above, transmission x-rays 234 pass through collimator 225 to first detector 220. Some of the x-rays 204 that impinge object 206 at sensitive volume 232 are caused to scatter as they pass therethrough, thus creating scatter beams of x-rays 236. The scatter beams of x-rays 236 pass through the collimator 225 and impinge upon the second detector 222 and third detector 224. Energy resolution of the small-angle spectrum in detectors 222 and 224 yields, after appropriate processing, the diffraction profile of material of object 206. The computer 231 receives data from detectors 220-224 and applies signal analysis algorithms thereto to extract features from the measured XRD profiles that include effective atomic number, inter-molecular potential, packing fraction, and molecular size, as examples. Once the analysis algorithms are applied, a computer such as computer 231 compares the XRD profiles to known threat substances and alerts the operator to potential threats.

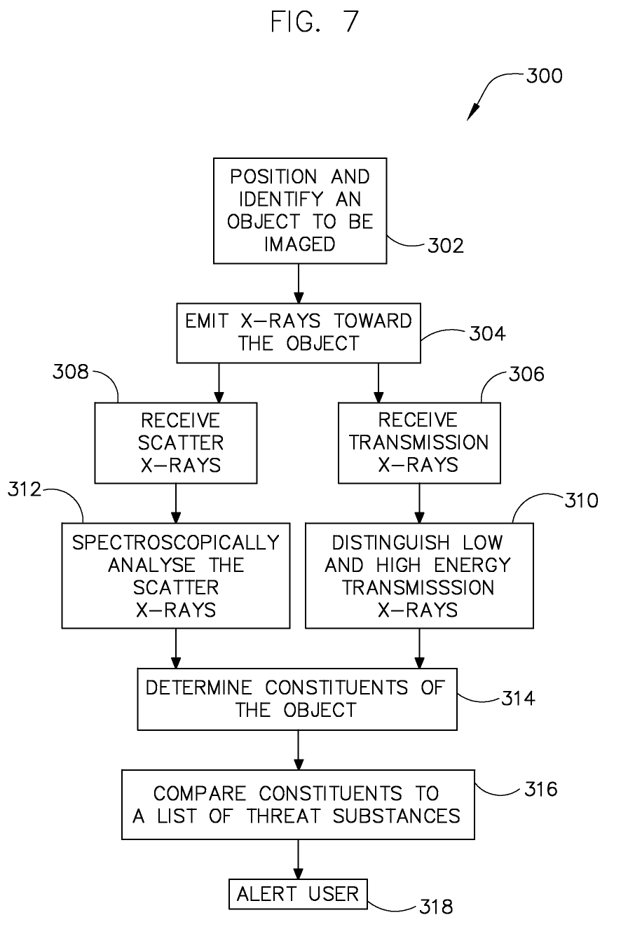

FIG. 7 illustrates a technique for identifying components of an object to be imaged and screened according to embodiments of the invention. Technique 300 begins by identifying and positioning the object to be imaged at step 302. The object may be positioned by a conveyor belt or by otherwise moving and positioning the object in the pathway of a beam of x-rays. In embodiments, the object is positioned proximate to an x-ray source, and an operator identifies the object or a location on the object to be imaged. In one embodiment, the object and/or location is identified by means of a video camera, by manually marking the object, by a laser pointer, and the like. The operator may base the identification on appearance of the object, shape of the object, or by other means that may raise suspicion as to the contents thereof. In one embodiment, once the object is identified, a system that may include an x-ray source, a scatter detector, a transmission detector, and pre- and post-object collimators is rotated or otherwise re-positioned and the object is moved along a conveyor such that x-rays may be emitted at step 304.

At step 306, transmission x-rays are received, and at step 308, scatter x-rays are received. In one embodiment the scatter x-rays are collimated through slits of a collimator at both 4° and 7°. Low- and high-energy x-rays are distinguished from transmission x-rays at step 310, and scatter x-rays are spectroscopically analyzed at step 312. At step 314, material composition or constituents of the object are identified based on information from both the scatter and transmission detectors. The constituents are identified by determining effective atomic number, inter-molecular potential, packing fraction, and molecular size, as examples. At step 316, the constituents of the object are compared to a list of threat substances that may reside in a database and may contain such constituents, and at step 318, a user is notified of the results and alerted if a threat substance is identified.

A technical contribution for the disclosed method and apparatus is that is provides for a computer implemented x-ray diffraction (XRD) system that determines a material composition of an object based on data received from x-ray transmission and scatter detectors.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A scanner, comprising:
a transmission detector;
an x-ray source positioned to emit a beam of x-rays toward the transmission detector;
a scatter detector positioned to receive x-rays scattered from the beam of x-rays by an object; and
a computer programmed to:
receive data from the transmission detector and from the scatter detector; and
determine a material composition of the object based on the data received from the transmission and scatter detectors.

2. The scanner of claim 1, wherein the computer is programmed to:
compare the determined material composition to a list of threat material compositions; and
alert a user to the results of the comparison.

3. The scanner of claim 1, wherein the object is one of a liquid in a container, a gel in a container, an amorphous substance, an explosive, and an unopened container constructed of one of metal, plastic, and glass.

4. The scanner of claim 1, wherein the computer is configured to count photons received in the scatter detector.

5. The scanner of claim 1, wherein the scatter detector comprises CdZnTe.

6. The scanner of claim 1, wherein the transmission detector is a dual-energy detector capable of distinguishing high-energy x-rays from low-energy x-rays.

7. The scanner of claim 1, wherein the transmission detector comprises:
a first detector positioned to receive x-rays that pass from the x-ray source through the object; and
a second detector positioned to receive x-rays that pass from the x-ray source and through the first detector.

8. The scanner of claim 1, comprising a scatter collimator positioned between the x-ray source and the scatter detector, the scatter collimator configured to collimate the x-rays scattered from the beam of x-rays.

9. The scanner of claim 8, comprising a primary collimator positioned between the x-ray source and the scatter collimator, the primary collimator configured to collimate x-rays that emit from the x-ray source.

10. The scanner of claim 1, comprising a rotatable turntable the transmission detector and the scatter detector mounted thereon.

11. The scanner of claim 1, comprising:
means for identifying a location on the object; and
means for positioning the object to receive x-rays at the identified location.

12. A method of scanning an object, comprising:
emitting x-rays toward an object and in a first direction from an x-ray source;
receiving x-rays in a first detector that pass through the object along the first direction;
receiving x-rays in a second detector that are scattered by the object along a second direction; and
determining a composition of the object based on the x-rays received in the first and second detectors.

13. The method of claim 12, wherein determining the composition comprises determining one of an effective atomic number, an intermolecular potential, a packing fraction, and a molecular size of the object.

14. The method of claim 12, comprising:
comparing the composition to a list of threat substances stored in a database; and
determining whether the object presents a threat based on the comparison.

15. The method of claim 12, comprising collimating the x-rays that emit from the x-ray source toward the object.

16. The method of claim 12, comprising collimating the scattered x-rays that are received in the second detector.

17. The method of claim 12, comprising identifying the object to be scanned by one of a video camera, an operator manually marking the object, optical recognition software, and a laser pointer.

18. A computer readable storage medium having stored thereon a program configured to:
cause x-rays to emit from a source toward an object;
receive data from a first detector, the first detector positioned to receive x-rays that pass through the object;
receive data from a second detector, the second detector positioned to receive x-rays that scatter from the object; and
determine a composition of the object based on the data received from the first and second detectors.

19. The computer readable storage medium of claim 18, wherein the program is configured to compare the composition to a list of threat compositions that reside in a database.

20. The computer readable storage medium of claim 18, wherein the x-rays received at one of the first and second detectors are collimated.

21. The computer readable storage medium of claim 18, wherein the computer is programmed to separate spectra of the received x-rays in the first detector into low and high energy bins.

22. The computer readable storage medium of claim 18, wherein the computer is programmed to count photons received in the second detector.
